(19) United States
(12) Patent Application Publication
(10) Pub. No.: US 2021/0294998 A1
(43) Pub. Date: Sep. 23, 2021

(54) READING DEVICE, INFORMATION PROCESSING SYSTEM, AND INFORMATION PROCESSING METHOD

(71) Applicant: TOSHIBA TEC KABUSHIKI KAISHA, Tokyo (JP)

(72) Inventor: Takashi ICHIKAWA, Tagata (JP)

(73) Assignee: TOSHIBA TEC KABUSHIKI KAISHA, Tokyo (JP)

(21) Appl. No.: 17/181,157

(22) Filed: Feb. 22, 2021

(30) Foreign Application Priority Data
Mar. 23, 2020 (JP) 2020-051345

(51) Int. Cl. G06K 7/14

(52) U.S. Cl. CPC G06K 7/1413

(57) ABSTRACT

A reading device includes a scanner, a mode changeover switch, and a processor. The scanner is configured to read a merchandise code from a code symbol attached to a merchandise. The scanner is operable in a registration mode and a cancellation mode. The mode changeover switch is configured to input an instruction for switching operation of the scanner between the registration mode and the cancellation mode. The processor configured to output mode information indicating whether the scanner is operating in the registration mode or the cancellation mode. The processor is also configured to output code information indicating the merchandise code read by the scanner.

### CROSS-REFERENCE TO RELATED APPLICATION

This application is based upon and claims the benefit of priority from Japanese Patent Application No. 2020-051345, filed on Mar. 23, 2020, the entire contents of which are incorporated herein by reference.

### FIELD

Embodiments described herein relate generally to a reading device, an information processing system, and an information processing method.

### BACKGROUND

In a cart point of sales (POS) of the related art, a merchandise scanner and a dedicated terminal operated by a customer are attached to a cart in advance, and are connected to each other by a cable. Barcode information obtained by reading the merchandise is transmitted by wire from the scanner to the dedicated terminal, and a POS application operates on the dedicated terminal.

However, when registering the merchandise to be purchased and when cancelling the registered merchandise and returning the merchandise to the shelf, the customer needs to operate a touch panel of the dedicated terminal. When cancelling the registered merchandise, there is also a case where it is necessary to scan the merchandise again after operating the touch panel.

### DESCRIPTION OF THE DRAWINGS

FIG. 1 is a block diagram illustrating a store system according to at least one embodiment;

FIG. 2 is a perspective view illustrating a cart;

FIG. 3 is a block diagram illustrating a reading device;

FIG. 4 is a block diagram illustrating an information processing device;

FIG. 5 is a flowchart illustrating a procedure of merchandise registration processing by the reading device;

FIG. 6 is a flowchart illustrating a procedure of merchandise registration processing by the information processing device; and

FIG. 7 is a flowchart illustrating a procedure of mode switching processing by the reading device.

### DETAILED DESCRIPTION

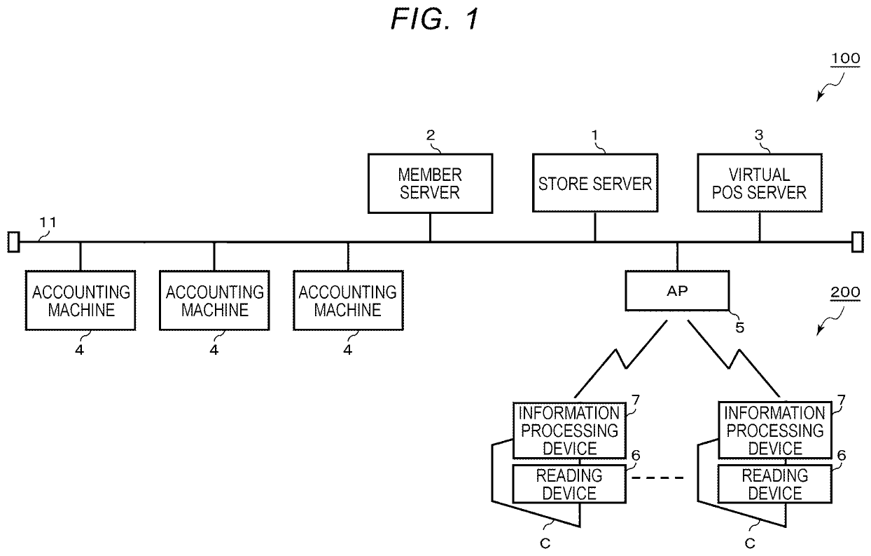

An object to be solved by embodiments described herein is to improve the operability of merchandise registration and cancellation. According to at least one embodiment, a reading device includes a reading unit, an input unit, a first output unit, and a second output unit. The reading unit reads a merchandise code from a code symbol attached to a merchandise. In the input unit, an instruction for switching a mode of the reading unit to a registration mode or a cancellation mode is input. The first output unit outputs mode information indicating the mode of the reading unit. The second output unit outputs code information indicating the merchandise code read by the reading unit. Hereinafter, an embodiment will be described with reference to the drawings. FIG. 1 is a block diagram illustrating a store system. A store system 100 includes a store server 1, a member server 2, a virtual POS server 3, an accounting machine 4, an access point (AP) 5, a reading device (reader) 6, and an information processing device 7. The reading device 6 and the information processing device 7 configure an information processing system 200. The store system 100 includes a network 11. The network 11 connects the store server 1, the member server 2, the virtual POS server 3, the accounting machine 4, and the access point 5 to each other to freely communicate with each other. The network 11 is, for example, a local area network (LAN). The store server 1, the member server 2, and the virtual POS server 3 may be a cloud server connected to a network such as the Internet (not illustrated) instead of the network 11.

The store server 1 supports store operations. For the support, the store server 1 stores a merchandise database, a sales database, and the like. The merchandise database stores a merchandise record on a per merchandise item basis sold in the store. The merchandise record includes a merchandise code, price, merchandise name, and the like. The merchandise code is an identification code of the merchandise. The sales database stores a sales record that describes sales data for each item such as merchandise, department, time zone, date, week, and month. The sales data includes the number of merchandise sold, the amount of sales, and the like.

The member server 2 supports the purchasing operation of a customer registered as a member, so-called member. For the support, the member server 2 stores the member database. The member database stores a member record that describes member data for each member. The member data includes a unique member identification (ID) assigned to each member in order to identify each member individually. The member data may include a cumulative value of service points given to the member, the history of merchandises purchased by the member, and the like. The virtual POS server 3 cooperates with the information processing device 7 to provide support for making the information processing device 7 appear to function as a POS terminal. The virtual POS server 3 stores a merchandise registration table for each customer. The customer is also called a buyer. The merchandise registration table includes a member ID, one or more pieces of merchandise data, and a total amount of money. The merchandise data is data related to the merchandise registered with the information processing device 7. The merchandise data is data including the merchandise code, merchandise name, price, number of items sold, sales amount, tax amount, and the like of the merchandise. The total amount is the sum of the sales amount and the tax amount included in the merchandise data. For example, the merchandise registration table is updated by the information processing device 7 using the merchandise database managed by the store server 1 and the member database managed by the member server 2. For example, the information processing device 7 adds the merchandise data of the registered merchandise to the merchandise registration table based on the merchandise code of the merchandise related to the registration. For example, the information processing device 7 cancels the merchandise data of the cancelled merchandise from the merchandise registration table based on the merchandise code of the merchandise related to the cancellation. The virtual POS server 3 transmits the merchandise registration table of the customer using the information processing device 7 to the accounting machine 4 based on an accounting instruction transmitted from the information processing device 7.

The accounting machine 4 is a device that enables a salesclerk or a customer to settle (account) the merchandise based on the merchandise registration table transmitted from the virtual POS server 3. The accounting machine 4 is a well-known self-service type POS terminal. The accounting machine 4 may be a well-known face-to-face-service type POS terminal. The number of accounting machines 4 is not limited. FIG. 1 illustrates the store system 100 in which three accounting machines 4 are installed in one store. The accounting machine 4 dispenses a receipt on which various pieces of information are printed. For example, the accounting machine 4 dispenses a receipt printed with information such as the price of each merchandise and total amount. The accounting machine 4 is an example of an output device that outputs various pieces of information by printing on a receipt.

The access point 5 relays data communication between the store server 1, the member server 2, the virtual POS server 3, the accounting machine 4, and the information processing system 200. Although only one access point 5 is illustrated in FIG. 1, there maybe two or more access points 5 depending on the size of the store and the like.

The information processing system 200 includes the reading device 6 and the information processing device 7. The information processing system 200 is provided in a shopping cart C. Hereinafter, the shopping cart C is simply referred to as a cart C. The information processing system 200 performs wireless communication with the access point 5. The number of carts C is not limited.

The reading device 6 and the information processing device 7 are devices used by the customer during shopping. “Shopping” is an operation for a customer to purchase a merchandise in a store. For example, “shopping” is an operation in which a customer reads a merchandise in a store with the reading device 6 and registers or cancels the merchandise with the information processing device 7 before the customer pays for the merchandise. The reading device 6 and the information processing device 7 are devices that enable the customer to input data related to the merchandise registration or cancellation by themselves. The reading device 6 and the information processing device 7 can also be called devices related to a customer who is shopping. For example, the reading device 6 outputs the merchandise code of the read merchandise to the information processing device 7. For example, the reading device 6 outputs mode information indicating the registration mode or the cancellation mode to the information processing device 7. For example, the information processing device 7 updates the merchandise registration table of the customer who uses the information processing device 7. For example, the information processing device 7 transmits an accounting instruction to the virtual POS server 3. A configuration example of the reading device 6 and the information processing device 7 will be described later.

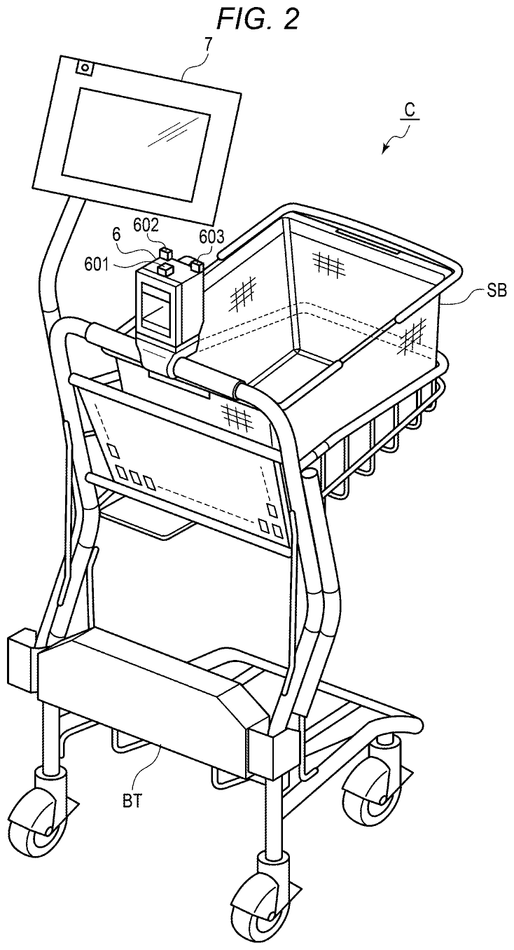

FIG. 2 is a perspective view illustrating the cart C. The cart C includes the information processing system 200 including the reading device 6 and the information processing device 7. A shopping basket (SB) provided in the store can be placed on the cart C. The shopping basket SB is for storing the merchandise.

The reading device 6 is at the middle part of a handlebar. The reading device 6 is attached to the handlebar such that a reading window is positioned on the near side. The near side is a side on which the customer who holds the handlebar and pushes the cart C stands. The reading device 6 includes a mode changeover switch 601, a registration mode lamp 602, and a cancellation mode lamp 603. A configuration example of the mode changeover switch 601, the registration mode lamp 602, and the cancellation mode lamp 603 will be described later.

The information processing device 7 is attached to the distal end portion of the pole with a screen of a touch panel 76 facing the near side. A battery (BT) is attached to the lower end side of a handle frame unit. The battery BT serves as a drive power source of the reading device 6 and the information processing device 7.

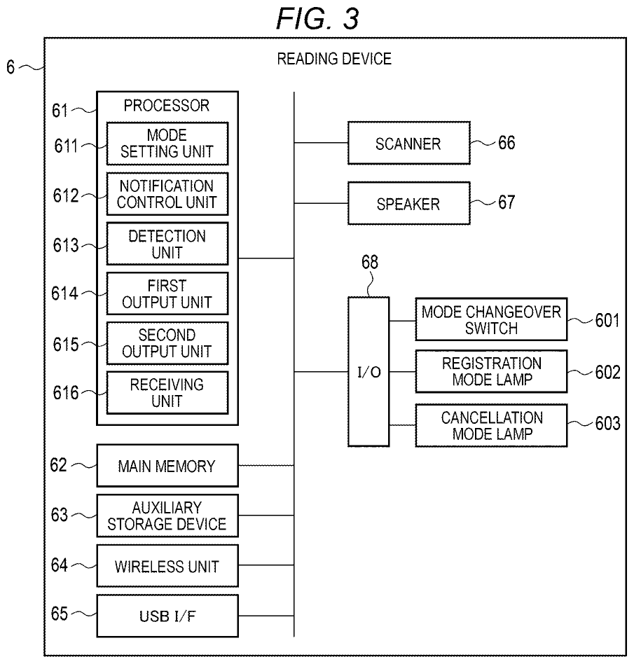

FIG. 3 is a block diagram illustrating the reading device 6. The reading device 6 is a computer including a processor 61 (first processor), a main memory 62, an auxiliary storage device 63, a wireless unit 64, a Universal Serial Bus (USB) interface 65, a scanner 66, a speaker 67, and an input/output interface 68. In FIG. 3, the interface is described as “I/F.” The input/output interface is described as “I/O.”

The processor 61 corresponds to the central part of the reading device 6. For example, the processor 61 is a central processing unit (CPU), but is not limited thereto. The processor 61 may be configured with various circuits. The processor 61 loads a program stored in advance in the main memory 62 or the auxiliary storage device 63 into the main memory 62. The program is a program that realizes each unit (as will be described later) in the processor 61 of the reading device 6. The processor 61 executes various operations by executing the program loaded in the main memory 62.

The main memory 62 corresponds to the main storage part of the reading device 6. The main memory 62 includes a non-volatile memory region and a volatile memory region. The main memory 62 stores an operating system or a program in a non-volatile memory region. The main memory 62 uses a volatile memory region as a work area where data is appropriately rewritten by the processor 61. For example, the main memory 62 includes a read only memory (ROM) as a non-volatile memory region. For example, the main memory 62 includes a random access memory (RAM) as a volatile memory region.

The auxiliary storage device 63 corresponds to an auxiliary storage part of the reading device 6. For example, the auxiliary storage device 63 is an electrically erasable program read-only memory (EEPROM), a hard disk drive (HDD), a solid state drive (SSD), or the like. The auxiliary storage device 63 stores the above-described program, data used by the processor 61 to perform various types of processing, and data generated by the processing performed by the processor 61. The wireless unit 64 performs wireless communication of data with the access point 5 according to a wireless communication protocol.

The USB interface 65 is an interface for connecting the reading device 6 and the information processing device 7 to each other with a wired USB cable. For example, the USB interface 65 transmits the code information of the merchandise related to the registration or cancellation, to the information processing device 7. For example, the USB interface 65 transmits the mode information indicating the mode of the reading device 6, to the information processing device 7.

The scanner 66 reads code symbols such as a barcode and a two-dimensional data code which are attached to the merchandise. The code symbol representing the merchandise code is attached to the merchandise. The scanner 66 outputs a merchandise code based on the read code symbol to the processor 61. The scanner 66 may be of a type that reads the code symbol by scanning a laser beam. The scanner 66 maybe a type that reads the code symbol from an image captured by an imaging device such as a camera. The scanner 66 is an example of a reading unit.

The speaker 67 outputs a sound when the merchandise is scanned. The speaker 67 is an example of a notification unit. The notification unit notifies whether the reading device 6 is in the registration mode or the cancellation mode. For example, the speaker 67 may output different sounds depending on whether the reading device 6 is in the registration mode or the cancellation mode.

The input/output interface 68 is an interface for communicably connecting the processor 61 with the mode changeover switch 601, the registration mode lamp 602, and the cancellation mode lamp 603. The mode changeover switch 601 is a switch for the customer to input an instruction for switching the mode of the reading device 6 to the registration mode or the cancellation mode. The mode of the reading device 6 corresponds to the mode of the scanner 66. The mode changeover switch 601 is an example of an input unit.

The registration mode lamp 602 is a lamp that turns on the light when the mode of the reading device 6 is the registration mode. The cancellation mode lamp 603 is a lamp that turns on the light when the mode of the reading device 6 is the cancellation mode. The registration mode lamp 602 and the cancellation mode lamp 603 (e.g., light emitters) are examples of the notification unit.

A hardware configuration of the reading device 6 is not limited to the above-described configuration. The reading device 6 makes it possible to omit or change the above-described configuration elements and to add a new configuration element as appropriate.

Each unit in the above-described processor 61 will be described. In the processor 61, a mode setting unit 611, a notification control unit 612, a detection unit 613, a first output unit 614, a second output unit 615, and a receiving unit 616 are implemented. Each unit in the processor 61 can also be called each function. Each unit in the processor 61 can also be functions implemented in a control unit including the processor 61 and the main memory 62.

The mode setting unit 611 sets the mode of the reading device 6 to the registration mode or the cancellation mode. For example, the mode setting unit 611 recognizes that the initial setting is the registration mode. For example, the mode setting unit 611 detects an instruction for switching the mode of the reading device 6 in the mode changeover switch 601 to the registration mode or the cancellation mode, and switches the current mode to the registration mode or the cancellation mode.

The notification control unit 612 controls the speaker 67, the registration mode lamp 602, and the cancellation mode lamp 603, and performs various notifications. For example, the notification control unit 612 turns on the registration mode lamp (an emitter) 602 when the reading device 6 is in the registration mode. The notification control unit 612 turns on the cancellation mode lamp 603 when the reading device 6 is in the cancellation mode. For example, the notification control unit 612 outputs a sound from the speaker 67 every time the scanner 66 reads the merchandise code. For example, the notification control unit 612 may output different sounds from the speaker 67 depending on whether the reading device 6 is in the registration mode or the cancellation mode.

The detection unit 613 detects whether the scanner 66 read the merchandise code from the code symbol attached to the merchandise. For example, the detection unit 613 detects that the scanner 66 read the merchandise code.

The first output unit 614 outputs the mode information of the reading device 6 to the information processing device 7. The second output unit 615 outputs the code information indicating the merchandise code read by the scanner 66, to the information processing device 7.

The receiving unit 616 receives a mode switching command from the information processing device 7. The mode switching command is a command for instructing to switch the mode of the reading device 6 to the registration mode or the cancellation mode.

The first output unit 614, the second output unit 615, and the receiving unit 616 were described as being implemented in the processor 61 by executing a program, but the present embodiment is not limited thereto. The first output unit 614, the second output unit 615, and the receiving unit 616 maybe realized by the USB interface 65. The first output unit 614 and the second output unit 615 may be realized respectively by different interfaces capable of communicating with the information processing device 7. The first output unit 614, the second output unit 615, and the receiving unit 616 may be realized in cooperation with a device such as the processor 61 and the USB interface 65 by executing a program.

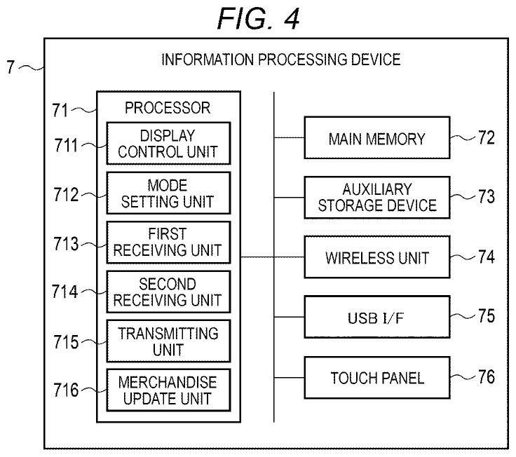

FIG. 4 is a block diagram illustrating the information processing device 7. The information processing device 7 is a computer including a processor 71 (second processor), a main memory 72, an auxiliary storage device 73, a wireless unit 74, a USB interface 75, and a touch panel 76. In FIG. 4, the interface is denoted as “I/F.”

The processor 71 corresponds to the central part of the information processing device 7. The processor 71 has the same hardware configuration as that of the above-described processor 61. The processor 71 loads a program stored in advance in the main memory 72 or the auxiliary storage device 73 into the main memory 72. The program is a program that realizes each unit (will be described later) in the processor 71 of the information processing device 7. The processor 71 executes various operations by executing a program loaded into the main memory 72.

The main memory 72 corresponds to the main storage part of the information processing device 7. The main memory 72 has the same hardware configuration as that of the above-described main memory 62. The main memory 72 stores the program.

The auxiliary storage device 73 corresponds to the auxiliary storage part of the information processing device 7. The auxiliary storage device 73 has the same hardware configuration as that of the above-described auxiliary storage device 63. The auxiliary storage device 73 may store a merchandise registration table having the same contents as those of the merchandise registration table stored in the virtual POS server 3 by the information processing device 7.

The wireless unit 74 performs wireless communication of data with the access point 5 according to a wireless communication protocol. The wireless unit 74 has the same hardware configuration as that of the above-described wireless unit 64.

The USB interface 75 is an interface for connecting the reading device 6 and the information processing device 7 to each other with a wired USB cable. For example, the USB interface 75 receives the code information from the reading device 6. For example, the USB interface 75 receives the mode information of the reading device 6 from the reading device 6.

The touch panel 76 is a device that includes both an input device and a display device of the information processing device 7. The touch panel 76 detects the touch position with respect to the displayed image and outputs the touch position information to the processor 71. For example, the touch panel 76 receives an input of an accounting instruction by a customer. For example, the touch panel 76 displays the mode information indicating the current mode of the information processing device 7. Hereinafter, the mode information indicating the mode of the information processing device 7 is also called mode information of the information processing device 7. The mode information of the information processing device 7 corresponds to the mode information of the reading device 6, received from the reading device 6 by the information processing device 7. The mode information of the information processing device 7 corresponds to the information indicating the operation mode set in the information processing device 7. The touch panel 76 is an example of a display unit (display).

A hardware configuration of the information processing device 7 is not limited to the above-described configuration. The information processing device 7 makes it possible to omit or change the above-described configuration elements and to add a new configuration element as appropriate.

Each unit in the above-described processor 71 will be described. In the processor 71, a display control unit (controller) 711, a mode setting unit (mode setter or modulator) 712, a first receiving unit (first receiver) 713, a second receiving unit (second receiver) 714, a transmitting unit (transmitter) 715, and a merchandise update unit 716 are mounted. Each unit mounted in the processor 71 can also be called by its function. Each unit mounted in the processor 71 can also be functions implemented in a control unit including the processor 71 and the main memory 72.

The display control unit 711 controls the touch panel 76, and causes the touch panel 76 to display the mode information of the information processing device 7. For example, when the display control unit 711 receives the mode information from the reading device 6, the display control unit 711 may change the display of the touch panel 76 according to the received mode information. For example, the display control unit 711 may display the information of the merchandise registration table. When the mode setting unit 712 receives the mode information from the reading device 6, the mode setting unit 712 switches the mode of the information processing device 7 to the registration mode or the cancellation mode according to the received mode information. For example, the mode setting unit 712 sets the mode of the information processing device 7 to be the registration mode when the mode information received from the reading device 6 indicates the cancellation mode and the merchandise data of the merchandise indicated by the code information received from the reading device 6 is not in the merchandise registration table.

The first receiving unit 713 receives the mode information from the reading device 6. The second receiving unit 714 receives the code information from the reading device 6.

The transmitting unit 715 transmits a mode switching command to the reading device 6. For example, the transmitting unit 715 transmits the mode switching command to the reading device 6 when the mode information received from the reading device 6 indicates the cancellation mode and the merchandise data of the merchandise indicated by the code information received from the reading device 6 is not in the merchandise registration table.

The merchandise update unit 716 adds or deletes merchandise data to or from the merchandise registration table. For example, the merchandise update unit 716 may add the merchandise data that corresponds to the received code information to the merchandise registration table in the registration mode. Addition includes registration. For example, in the cancellation mode, the merchandise update unit 716 may delete the merchandise data that corresponds to the received code information from the merchandise registration table. In at least one embodiment, the deletion includes cancellation.

The first receiving unit 713, the second receiving unit 714, and the transmitting unit 715 were described as being implemented in the processor 71 by executing a program, but the present embodiment is not limited thereto. The first receiving unit 713, the second receiving unit 714, and the transmitting unit 715 may be realized by the USB interface 75. The first receiving unit 713 and the second receiving unit 714 may be realized respectively by different interfaces capable of communicating with the reading device 6. The first receiving unit 713, the second receiving unit 714, and the transmitting unit 715 may be realized in cooperation with a device such as the processor 71 and the USB interface 75 by executing a program.

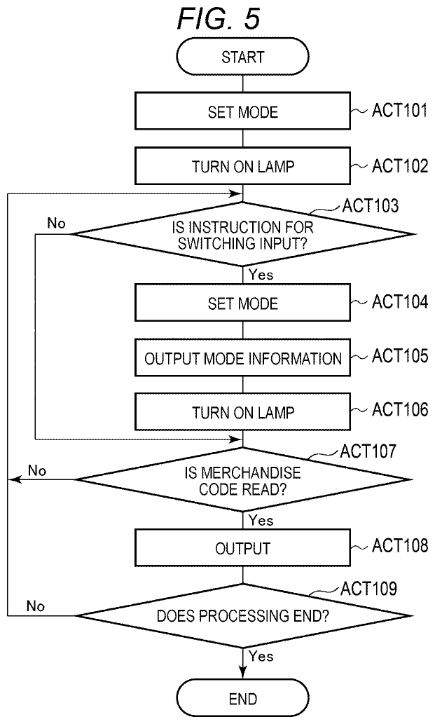

The procedure of processing by the reading device 6 will be described. First, the merchandise registration processing by the reading device 6 will be described. FIG. 5 is a flowchart illustrating the procedure of the merchandise registration processing by the reading device 6. The mode setting unit 611 sets the mode of the reading device 6 (ACT 101). For example, the initial setting of the reading device 6 is the registration mode. In ACT 101, for example, the mode setting unit 611 sets the mode of the reading device 6 to be the registration mode according to the initial setting.

The notification control unit 612 controls and turns on the registration mode lamp 602 (ACT 102). In ACT 102, for example, the notification control unit 612 turns on the registration mode lamp 602 to notify that the reading device 6 is in the registration mode. For example, the notification control unit 612 may control the speaker 67 and output a sound indicating that the reading device 6 is in the registration mode from the speaker 67.

The mode setting unit 611 detects whether an instruction for switching the mode of the scanner 66 is input by the mode changeover switch 601 (ACT 103). In ACT 103, for example, the mode setting unit 611 detects that the instruction for switching the mode of the scanner 66 from the registration mode to the cancellation mode is input by the mode changeover switch 601. The mode setting unit 611 detects that the instruction for switching the mode of the scanner 66 from the registration mode to the cancellation mode is input by the mode changeover switch 601. For example, the mode setting unit 611 receives a signal that corresponds to the instruction input by the mode changeover switch 601 from the mode changeover switch 601 and detects the mode changeover.

When the mode setting unit 611 does not detect the input of the instruction for switching the mode (ACT 103, NO), the processing transitions from ACT 103 to ACT 107. When the mode setting unit 611 detects the input of the instruction for switching the mode (ACT 103, YES) , the mode setting unit 611 switches the mode of the reading device 6 to the registration mode or the cancellation mode in response to the input instruction (ACT 104) . In ACT 104, for example, when the instruction for switching the mode to the cancellation mode by the mode changeover switch 601, the mode setting unit 611 sets the mode of the reading device 6 to be the cancellation mode. The customer can easily switch the mode of the scanner 66 by operating the mode changeover switch 601 and can make it easy to perform the operations of registering and cancelling the merchandise. By providing the mode switching function in the reading device 6, it is possible to contribute to the miniaturization of the information processing device 7.

The first output unit 614 outputs the mode information of the reading device 6 in response to the input of the instruction for switching the mode of the reading device 6 (ACT 105) . In ACT 105, for example, the first output unit 614 outputs the mode information of the reading device 6 set in ACT 104 in response to the input detected in ACT 103. For example, when the mode of the reading device 6 is set to the cancellation mode in response to the input detected in ACT 103, the first output unit 614 outputs the mode information indicating the cancellation mode to the information processing device 7.

The notification control unit 612 controls and turns on the registration mode lamp 602 or the cancellation mode lamp 603 according to the mode set in ACT 104 (ACT 106) . In ACT 106, for example, the notification control unit 612 controls and turns on the cancellation mode lamp 603 when the cancellation mode is set in ACT 104. For example, the notification control unit 612 may control the speaker 67 in the same manner and output a sound according to the mode set in ACT 104. Since the reading device 6 turns on different lamps according to the registration mode or the cancellation mode, the customer can easily confirm the current mode of the reading device 6. Since the speaker 67 outputs different sounds according to the registration mode or the cancellation mode, the customer can easily confirm the current mode of the reading device 6.

The detection unit 613 detects whether the scanner 66 read the merchandise code from the code symbol attached to the merchandise (ACT 107). When the detection unit 613 does not detect that the scanner 66 read the merchandise code (ACT 107, NO), the processing transitions from ACT 107 to ACT 103. When the detection unit 613 detects that the scanner 66 read the merchandise code (ACT 107, YES), the first output unit 614 outputs the mode information indicating the mode of the reading device 6, and the second output unit 615 outputs the code information indicating the merchandise code read by the scanner 66 (ACT 108). In ACT 108, for example, the first output unit 614 outputs the mode information when the second output unit 615 outputs the code information. For example, the first output unit 614 outputs the mode information at the same timing as or substantially the same as the timing at which the second output unit 615 outputs the code information. For example, every time the second output unit 615 outputs the code information, the first output unit 614 outputs the mode information. Therefore, even when the reading device 6 outputs only the mode information to the information processing device 7 in advance and the information processing device 7 cannot acquire the mode information due to some communication failures or the like, it is possible to prevent the information processing device 7 from continuing to operate in an erroneous mode. Since the reading device 6 outputs the code information and the mode information together to the information processing device 7, it is possible to prevent the merchandise data from being accidentally added to or deleted from the merchandise registration table.

When the end button (not illustrated) is pressed by the customer (ACT 109, YES) , the processing ends. When the end button is not pressed (ACT 109, NO), the processing transitions from ACT 109 to ACT 103.

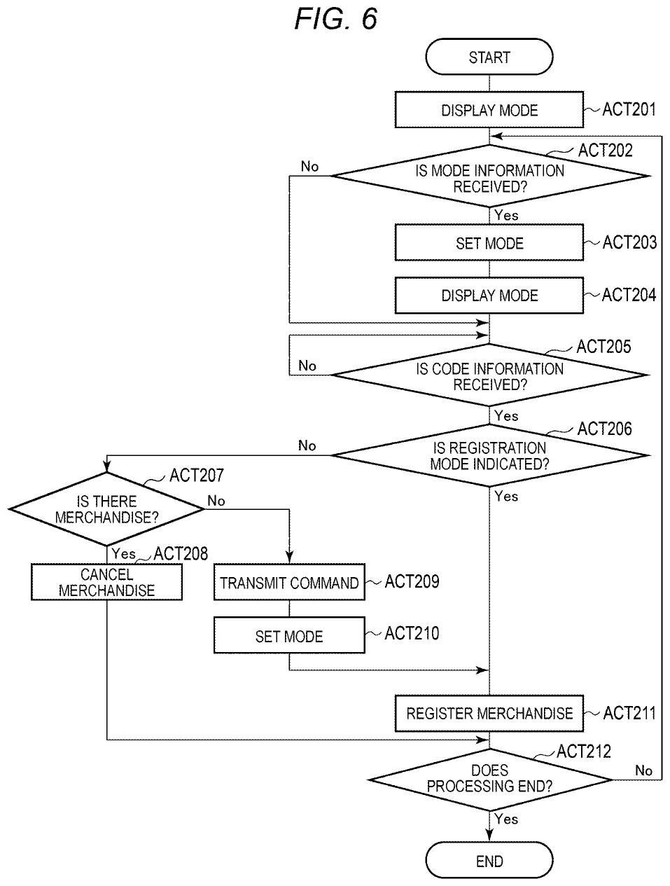

Next, the merchandise registration processing by the information processing device 7 will be described. FIG. 6 is a flowchart illustrating a procedure of the merchandise registration processing by the information processing device 7.

The display control unit 711 controls the touch panel 76 to display the mode information of the information processing device 7 (ACT 201). For example, the initial setting is the registration mode. In ACT 201, for example, the display control unit 711 causes the touch panel 76 to display that the mode of the information processing device 7 is the registration mode.

The first receiving unit 713 determines whether the mode information was received from the reading device 6 (ACT 202) . In ACT 202, for example, the first receiving unit 713 waits for the mode information output from the reading device 6 to the information processing device 7 in the above-described ACT 105. When it is determined that the first receiving unit 713 did not receive the mode information (ACT 202, NO), the processing transitions from ACT 202 to ACT 205. When the first receiving unit 713 determines that the mode information was received (ACT 202, YES), the mode setting unit 712 sets the mode of the information processing device 7 to be the registration mode or the cancellation mode according to the received mode information (ACT 203) . In ACT 203, for example, when the mode setting unit 712 receives the mode information indicating the cancellation mode from the reading device 6 in ACT 202, the mode setting unit 712 switches the mode of the information processing device 7 to the cancellation mode.

The display control unit 711 causes the touch panel 76 to display the mode information received by the first receiving unit 713 (ACT 204). In ACT 204, for example, the display control unit 711 controls the touch panel 76 to display the mode information of the information processing device 7 set in ACT 203 in response to the mode information of the reading device 6 received in ACT 202. By displaying the mode information of the information processing device 7 on the touch panel 76, the customer can easily confirm the current mode of the information processing device 7. The customer can easily grasp the mode mismatch between the two modes by mutually confirming the mode display of the touch panel 76 and the ON state of the registration mode lamp 602 or the cancellation mode lamp 603 indicating the mode of the reading device 6.

The first receiving unit 713 determines whether the mode information was received, and the second receiving unit 714 determines whether the code information was received (ACT 205). In ACT 205, for example, the first receiving unit 713 waits for the mode information output from the reading device 6 to the information processing device 7 in the above-described ACT 108. The second receiving unit 714 waits for the code information output from the reading device 6 to the information processing device 7 in the above-described ACT 108. For example, the first receiving unit 713 receives the mode information at the same timing as or substantially the same as the timing at which the second receiving unit 714 receives the code information. For example, every time the second receiving unit 714 receives the code information, the first receiving unit 713 receives the mode information. When the first receiving unit 713 determines that the mode information is not received and the second receiving unit 714 determines that the code information is not received (ACT 205, NO), the processing repeats ACT 205. When the first receiving unit 713 determines that the mode information was received and the second receiving unit 714 determines that the code information was received (ACT 205, YES), the mode setting unit 712 determines that the received mode information is the registration mode (ACT 206).

When the mode setting unit 712 determines that the received mode information indicates the registration mode (ACT 206, YES), the processing transitions from ACT 206 to ACT 211. When the mode setting unit 712 determines that the received mode information does not indicate the registration mode (ACT 206, NO), the merchandise update unit 716 determines whether the merchandise that corresponds to the received code information is in the merchandise registration table (ACT 207). A case where the received mode information does not indicate the registration mode corresponds to a case where the received mode information indicates the cancellation mode.

When the merchandise update unit 716 determines in ACT 206 that the merchandise that corresponds to the code information received by the second receiving unit 714 is in the merchandise registration table (ACT 207, YES), the merchandise data that corresponds to the merchandise is deleted from the merchandise registration table (ACT 208). In ACT 208, the mode of the information processing device 7 is set to be the cancellation mode. Here, the processing transitions from ACT 208 to ACT 212.

When the merchandise update unit 716 determines in ACT 206 that the merchandise that corresponds to the code information received by the second receiving unit 714 is not in the merchandise registration table (ACT 207, NO), the transmitting unit 715 transmits the mode switching command to the reading device 6 (ACT 209). In ACT 209, for example, the transmitting unit 715 transmits the mode switching command for instructing the reading device 6 to switch the mode to the registration mode, to the reading device 6. Accordingly, the customer does not need to perform an operation of switching the mode of the reading device 6 to the registration mode with the mode changeover switch 601.

The mode setting unit 712 switches the mode of the information processing device 7 to the registration mode (ACT 210). In ACT 210, for example, the mode setting unit 712 sets the mode of the information processing device 7 to the registration mode when the received mode information indicates the cancellation mode and the merchandise that corresponds to the code information is not in the merchandise registration table. Accordingly, the information processing device 7 can set the mode of the information processing device 7 to the registration mode without requiring the operation of the mode changeover switch 601 in the reading device 6. Even when the customer mistakenly tries to register the merchandise in the cancellation mode, the information processing device 7 can register the merchandise in the merchandise registration table without requiring an additional operation.

The merchandise update unit 716 registers the merchandise that corresponds to the code information received by the second receiving unit 714 in ACT 205, in the merchandise registration table (ACT 211). In ACT 211, the mode of the information processing device 7 is set to be the registration mode.

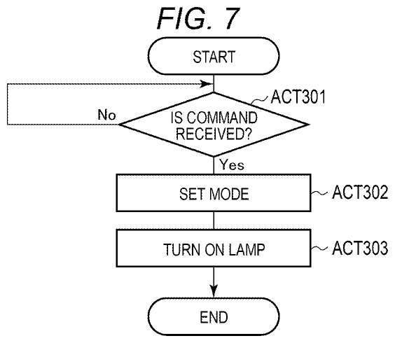

When the end button (not illustrated) is pressed by the customer (ACT 212, YES), the processing ends. When the end button is not pressed (ACT 212, NO), the processing transitions from ACT 212 to ACT 202. First, the mode switching processing by the reading device 6 will be described. FIG. 7 is a flowchart illustrating the procedure of the mode switching processing by the reading device 6.

The receiving unit 616 determines whether the mode switching command was received from the information processing device 7 (ACT 301). In ACT 301, for example, the receiving unit 616 receives the mode switching command for instructing to switch the mode of the reading device 6 from the cancellation mode to the registration mode, from the information processing device 7. When the receiving unit 616 determines that the mode switching command was not received (ACT 301, NO), ACT 301 is repeated. When the receiving unit 616 determines that the mode switching command was received (ACT 301, YES), the mode setting unit 611 switches the mode of the reading device 6 (ACT 302). In ACT 302, for example, the mode setting unit 611 sets the mode of the reading device 6 to the registration mode in response to the mode switching command for instructing to switch the mode to the registration mode, which is received from the receiving unit 616.

The notification control unit 612 controls and turns on the registration mode lamp 602 (ACT 303). In ACT 303, for example, the notification control unit 612 turns on the registration mode lamp 602 to notify that the reading device 6 is in the registration mode. For example, the notification control unit 612 may control the speaker 67 and output a sound indicating that the reading device 6 is in the registration mode. The reading device 6 may control the speaker 67 in response to the mode switching command and output a warning sound or voice for notifying the mode change.

Although an example in which the information processing device 7 performs the processing of registering and cancelling the merchandise to and from the merchandise registration table was described, the present embodiment is not limited thereto. For example, the information processing device 7 is a terminal such as a tablet or a smartphone that only has a display function, and the virtual POS server may perform the processing of registering and cancelling the merchandise. Here, since each unit of the information processing device 7 is implemented, the virtual POS server 3 can also be an example of the information processing device. The reading device 6 can send the mode information and the code information to the virtual POS server 3 via the wireless unit 64.

The transfer of the information processing device is generally performed in a state where the program is stored in the main memory or the auxiliary storage device. However, the present embodiment is not limited thereto, and the program may be transferred without being stored in the main memory or the auxiliary storage device. Here, the program transferred separately from the information processing device is written in the writable storage device included in the information processing device according to the operation of the user or the like. The transfer of the program can be performed by recording on a removable recording medium or by communicating via a network. The recording medium can be in any form such as a CD-ROM or a memory card as long as it is possible to store a program and the device can read the program. The function obtained by installing or downloading the program may realize the function in cooperation with an operating system (OS) inside the device. While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed is:

1. A reading device comprising:
a scanner configured to read a merchandise code from a code symbol attached to a merchandise, the scanner operable in a registration mode and a cancellation mode;
a mode changeover switch configured to input an instruction for switching operation of the scanner between the registration mode and the cancellation mode; and
a processor configured to:
output mode information indicating whether the scanner is operating in the registration mode or the cancellation mode; and
output code information indicating the merchandise code read by the scanner.

2. The reading device of claim 1, wherein the processor is further configured to:
receive the instruction from the mode changeover switch; and
output the mode information after receiving the instruction.

3. The reading device of claim 1, wherein the processor is further configured to:
receive the instruction from the mode changeover switch; and
output the mode information and the code information concurrently.

4. The reading device of claim 1, further comprising a registration mode emitter that is configured to be selectively illuminated;
wherein the processor is further configured to cause the registration mode emitter to be illuminated while the scanner is operating in the registration mode.

5. The reading device of claim 4, further comprising a cancellation mode emitter that is configured to be selectively illuminated;
wherein the processor is further configured to cause the cancellation mode emitter to be illuminated while the scanner is operating in the cancellation mode.

6. The reading device of claim 5, further comprising a speaker that is configured to selectively output a first sound;
wherein the processor is further configured to cause the speaker to output the first sound while the scanner is operating in the registration mode.

7. The reading device of claim 6, wherein the speaker is configured to selectively output a second sound while the scanner is operating in the cancellation mode.

8. An information processing system comprising:
a reading device comprising:
a scanner configured to read a merchandise code from a code symbol attached to a merchandise, the scanner operable in a registration mode and a cancellation mode,
a mode changeover switch configured to input an instruction for switching operation of the scanner between the registration mode and the cancellation mode, and
a first processor configured to:
output mode information indicating whether the scanner is operating in the registration mode or the cancellation mode, and
output code information indicating the merchandise code read by the scanner;
a display;
an information processing device comprising a second processor configured to:
receive the mode information from the reading device, and
cause the display to display the mode information.

9. The information processing system of claim 8, wherein the first processor is further configured to:
receive the instruction from the mode changeover switch; and
output the mode information to the second processor after receiving the instruction.

10. The information processing system of claim 8, wherein the first processor is further configured to:
receive the instruction from the mode changeover switch; and
output the mode information and the code information concurrently.

11. The information processing system of claim 8, wherein the reading device further comprises a registration mode emitter that is configured to be selectively illuminated;
wherein the first processor is further configured to cause the registration mode emitter to be illuminated while the scanner is operating in the registration mode.

12. The information processing system of claim 11, wherein the reading device further comprises a cancellation mode emitter that is configured to be selectively illuminated;
wherein the first processor is further configured to cause the cancellation mode emitter to be illuminated while the scanner is operating in the cancellation mode.

13. The information processing system of claim 12, wherein the reading device further comprises a speaker that is configured to selectively output a first sound;
wherein the first processor is further configured to cause the speaker to output the first sound while the scanner is operating in the registration mode.

14. The information processing system of claim 13, wherein the speaker is configured to selectively output a second sound while the scanner is operating in the cancellation mode.

15. An information processing system comprising:
a reading device comprising:
a scanner configured to read a merchandise code from a code symbol attached to a merchandise, the scanner operable in a registration mode and a cancellation mode,
a mode changeover switch configured to input an instruction for switching operation of the scanner between the registration mode and the cancellation mode, and
a first processor configured to:
output mode information indicating whether the scanner is operating in the registration mode or the cancellation mode, and
output code information indicating the merchandise code read by the scanner; and
an information processing device comprising a second processor configured to:
receive the mode information from the first processor,
receive the code information from the first processor,
determine whether the merchandise is in a stored table based on the code information, and
transmit a mode switching command to the reading device while the scanner is operating in the cancellation mode and the merchandise is not in the stored table.

16. The information processing system of claim 15, wherein the first processor is further configured to:
receive the mode switching command from the second processor, and
cause the scanner to operate in the registration mode after receiving the mode switching command when the scanner is operating in the cancellation mode.

17. The information processing system of claim 16, wherein the second processor is further configured to register the merchandise in the stored table after transmitting the mode switching command.

18. A method of using an information processing system including a reader and an information processor, the reader including a scanner, the method comprising:
determining, by the reader, whether the scanner is operating in a registration mode or a cancellation mode;
detecting, by the reader, an instruction for switching a mode of the scanner to one of the registration mode or the cancellation mode;
detecting, by the reader, that a merchandise code attached to a merchandise is read by the scanner;
determining, by the reader, a code symbol based on the merchandise code;
outputting, by the reader, mode information indicating whether the scanner is operating in the registration mode or the cancellation mode to the information processor; and
outputting, by the reader, code information indicating the merchandise code to the information processor.

19. The method of claim 18, further comprising:
receiving, by the information processor, the mode information from the reader;
receiving, by the information processor, the code information from the reader; and
determining, by the information processor, whether the merchandise is in a stored table based on the code information.

20. The method of claim 19, further comprising transmitting, by the information processor, a mode switching command to the reader while the scanner is operating in the cancellation mode and the merchandise is not in the stored table.
